(19) United States
(12) Patent Application Publication
(10) Pub. No.: US 2003/0159836 A1
(43) Pub. Date: Aug. 28, 2003

(54) Fire-extingushing agent, water for fire extinguishing and method of fire extinguishing

(76) Inventors: Keizou Kashiki, Kobe-shi (JP); Masatoshi Sumitani, Kobe-shi (JP); Kojiro Sakae, Kobe-shi (JP); Shigeru Komatsu, Kobe-shi (JP); Takshi Maruyama, Omiya-shi (JP); Yanfeng Wang, Yatsuhiro-shi (JP)

Correspondence Address: Oliff & Berridge, PO Box 19928, Alexandria, VA, 22320, US

(21) Appl. No.: 10/296,922

(22) PCT Filed: Apr. 20, 2001
(86) PCT No.: PCT/JP01/03394

(51) Int. Cl. A62D 1/00

(52) U.S. Cl. 169/46; 169/DIG. 2; 252/2

(57) ABSTRACT

The object of the present invention is to provide a fire extinguishing agent that can extinguish fire and check the spread of fire by easily containing water therein by means of heat due to the fire and solidifying thereby adhering to a burning object; a fire extinguishing water and a method for extinguishing fire by using it. Concretely, the present invention relates to a fire extinguishing agent comprising a thermosensitive polymer that is water-soluble at a temperature not more than a specific preset temperature and that gels or solidifies by containing water therein by means of heat due to a fire which attains to a temperature not less than the preset temperature; a fire extinguishing water obtained by dissolving the fire extinguishing agent into water optionally with a flameproofing agent or other fire extinguishing fire agent; and a method for extinguishing fire using the fire extinguishing water.

### TECHNICAL FIELD

The present invention relates to a fire extinguishing agent that can keep water for fire extinguishing on a surface of an object to be quenched or the like, a fire extinguishing water and a method for extinguishing fire by using the same.

### BACKGROUND ART

Water resources have advantages that those are relatively abundantly present in nature and most convenient to utilize easily. In addition, most of prior fire extinguishing agents have been used by diluting those with a large amount of water as water has many advantages in case where a fire is quenched. First of all, water has a high specific heat and evaporation heat, therefore it causes a evaporative cooling effect. Water removes heats from a burning object with evaporation, and thereby it can lower a temperature of the burning object below its ignition temperature to exert a fire extinguishing effect. Further, when water is completely vaporized in high temperature region, it forms around a burning object a water vapor layer with which an air layer is replaced and thus oxygen required for combustion is blocked thereby it is able to prevent a fire.

On the other hand, when a fire fighting is carried out with water, there are also many serious disadvantages. That is, as water has a low viscosity and good fluidity, it can not remain on a surface of a burning object for a while and tends to fall at once and flow on the ground. In addition, when a heating power in the combustion grows strong, water becomes difficult to go near a surface of a burning object, and a high temperature causes water scattering or evaporation. Consequently, it is required to spray water continuously for a long time. However, usable water-source is rarely present in dry areas, such as forests and fields, grassy planes or mountains, thus only limited amount of water must be effectively used on a fire in such an area.

Further, on a fire fighting, a large amount of water is fallen and flowed as described above. Therefore, in particular, in case where a fire in an upper story of a high-rise building is quenched, there is a problem causing a secondary accident that water is infiltrated into downer stories that have no direct relation with the fire or scattered to neighboring buildings.

In order to resolve these problems resulting from the use of water for extinguishing fire, many remedial measures have been proposed. Among them, there are several methods for inhibiting run-off of water from a burning object, in which is used a mixture obtained by mixing powdery, granular or dispersed liquid polymer gel having high water absorption capacity that is not soluble in water, into a fire extinguishing water. For example, U.S. Pat. No. 5,190,110 teaches that an adsorptive cross-linked polymer having a particle size ranging from 20 to 500 μm is dispersed into a water-compatible medium such that the viscosity of the resulting gel solution is not over 100 mPa.s. However, this system does not confer a time sufficient to swell upon the adsorptive gel particles that are a carrier for water, and does not have a viscosity sufficient to make the particles adhere to the surface of a burning object on fire fighting.

In addition, Japanese Patent Laid-open No. 05-305153 proposes a use of an adhesive fire extinguishing water that contains an edible konjak-like agglomerate obtained by coagulating konjakmannan particles with a coagulating agent, such as calcium, or that contains a konjak powder. However, as this method uses a fire extinguishing water containing water-insoluble konjak, there is a fear that a fire pump, a fire hose or a fire hose nozzle is clogged with the konjak when the fire extinguishing water is spurted.

Further, Japanese Patent Laid-open No. 10-155932 discloses a fire extinguishing composition in which a granular and highly water absorbing polymer is impregnated with a water system fire extinguishing agent having fire extinguishing function, and a fire extinguishing method comprising spraying the composition. However, the publication dose not fully describe a viscosity of water absorbing polymer medium used in fire extinction nor a problem causing a larger agglomerate due to an adhesion between swollen granules.

U.S. Pat. No. 4,978,460 teaches to add a water-soluble dispersant suitable to prevent polymer gel particles aggregating each other. When a fire fighting is done with a general length of fire hose using this system, the polymer particles take longer to be swollen and it is necessary to add the polymer gel particles in a high concentration in order to attain a desired amount of absorbed water.

As mentioned above, typical highly water absorbing polymers added in a fire extinguishing water have a large particle size, such as a particle size more than 20 μm. Therefore, as “water gel” added to a fire extinguishing water is granular and has a solid property, a fire extinguishing apparatus standard at the present state of the art is clogged due to an aggregation of the gel particles when the water gel is spurted from the apparatus. Thus, it is difficult to use the above-mentioned water gel in many fire fightings even though it would not be impossible.

Japanese Patent Laid-open No. 09-140826 discloses a fire preventing and fire extinguishing water containing a water swelling polymer having a small particle size less than 1 μm that is cross-linked in a water-in-oil type and that is generated by a reversed phase polymerization. In addition, the publication emphasizes the use of polymer particles capable of inducing them in a form of liquid into water to be supplied, and teaches the use of highly viscous fluid having a viscosity of 500 to 50000 mPa.s in order to make the water adhere to both vertical surface and horizontal surface of a burning object. Although this system was substantially improved in a solution to the problem of typical and highly water absorbing polymer particles, the water absorbing polymer particles are insoluble in water and have problems that they adhere to a fire extinguisher or causes troubles in its operation. Therefore, this system is still in the experimental phase.

On the other hand, in fires in general houses, fires resulting from oil used in cooking represented by tempura show a tendency to increase in number more and more in recent years. Taking the housing condition in urban areas into consideration, fires in general houses may cause a good deal of damages. Therefore, it is necessary to extinguish fire in early stage thereof by a reliable and safe method.

Conventionally, widely used fire extinguishing agents include those of powder system, gas system and water system. In case of fires resulting from tempura oil, it is regarded that the use of a fire extinguishing agent of water system is preferable, as the oil is ignited again unless the temperature of the oil is lowered below its ignition point. However, the prior fire extinguishing agents of water system have problems that they bring about the boil, the extinguishing liquid therein shows alkaline and they make the flame of fires rise up highly.

Taking these problems into consideration, an object of the present invention is to provide a fire extinguishing agent and a fire extinguishing water that can be handled similarly to the prior fire extinguishing waters and that can keep sprayed fire extinguishing water on a surface of a burning object.

Another object of the present invention is to provide a fire extinguishing agent and a fire extinguishing water that exerts excellent fire extinguishing effect even on fires resulting from oil, such as tempura oil.

### DISCLOSURE OF INVENTION

The present inventors studied variously looking for a material that water-containing mixture obtained by adding it into a “water” for extinguishing fire is still homogeneous liquid at ambient temperatures, has a relatively low viscosity and fluidity, and thus can be adequately used in a known fire pump and the like, that can gel or solidify in a state which the material contains a large amount of water on a surface of a burning object thereby exerting air-blocking and cooling effects, and that can have excellent fire extinguishing effect even against oil fires. As a result of this, they found that thermosensitive polymers can realize the above-mentioned objects, and completed the present invention.

That is, the present invention is as follows:

1. A fire extinguishing agent characterized by comprising a thermosensitive polymer that is water-soluble at a temperature not more than a specific preset temperature and that solidifies by containing water therein at a temperature not less than the preset temperature;

2. The fire extinguishing agent as set forth in the item 1, wherein the solidified thermosensitive polymer is a hydrogel;

3. The fire extinguishing agent as set forth in the item 1 or 2, wherein the thermosensitive polymer is a water-soluble polyacrylamide polymer;

4. The fire extinguishing agent as set forth in any one of the items 1 to 3, wherein the thermosensitive polymer is a polymer comprising N-isopropylacrylamide as a main component;

5. The fire extinguishing agent as set forth in any one of the items 1 to 4, wherein the thermosensitive polymer is a polymer obtained by copolymerizing 75 to 99 mol % of N-isopropylacrylamide and 1 to 25 mol % of sodium acrylate;

6. The fire extinguishing agent as set forth in the item 1, wherein the thermosensitive polymer is a cellulose derivative;

7. The fire extinguishing agent as set forth in the item 6, wherein the cellulose derivative has a molecular weight not less than 15000;

8. The fire extinguishing agent as set forth in the item 6 or 7, wherein the cellulose derivative is one or more selected from alkyl-substituted cellulose, hydroxyalkyl-substituted cellulose, hydroxyalkylalkyl-substituted cellulose, polyalkyleneoxyl-substituted cellulose and a cellulose obtained by grafting a vinyl monomer;

9. The fire extinguishing agent as set forth in the item 8, wherein the alkyl-substituted cellulose is composed of mainly methyl cellulose (methoxyl group %: 26 to 33);

10. The fire extinguishing agent as set forth in the item 8, wherein the hydroxyalkylalkyl-substituted cellulose is composed of mainly hydroxypropylmethyl cellulose (methoxyl group %: 17 to 31, hydroxypropyl group %: no more than 15);

11. The fire extinguishing agent as set forth in the item 8, wherein the vinyl monomer is one that the homopolymer thereof has a lower critical solution temperature in a state of aqueous solution;

12. The fire extinguishing agent as set forth in the item 8, wherein the vinyl monomer is one having an anion group;

13. A fire extinguishing water characterized by dissolving the fire extinguishing agent as set forth in any one of the items 1 to 12 into water;

14. The fire extinguishing water as set forth in the item 13, containing a fire extinguishing agent, a flameproofing agent or an introfier besides the thermosensitive polymer;

15. The fire extinguishing water as set forth in the item 14, wherein the fire extinguishing agent is one or more selected from ammonium primary (secondary) phosphate, potassium bicarbonate, potassium borate and potassium acetate;

16. The fire extinguishing water as set forth in the item 14, wherein the introfier is dioctylsulfosucuccinate;

17. The fire extinguishing water as set forth in any one of the items 13 to 16, wherein the viscosity of the aqueous solution is 20 to 2000 mPa.s (30° C.); and

18. A method for extinguishing fire characterized by using the fire extinguishing water as set forth in any one of the items 13 to 17.

The thermosensitive polymer used in the present invention is defined as “a thermosensitive polymer that is water-soluble at a temperature not more than a specific preset temperature (hereinafter, referred to as thermosensitive point) and that solidifies (forms water-insoluble hydrogel) at a temperature not less than the thermosensitive point.

In the present invention, the thermosensitive polymer is added as a fire extinguishing agent into water for extinguishing fire to give an aqueous solution that has a fluidity at an ambient temperature and that can be used for extinguishing fire by using through a conventional fire extinguishing tool, such as a fire pump similarly to a fire extinguishing water. When the aqueous solution is spurted or sprayed to a firing object (a burning object), it remains on the surface of the burning object in the form of gel or solid containing water by means of heat due to burning. Thus, it can extinguish fire, check the spread of fire and prevent re-ignition.

The thermosensitive polymer in the present invention includes, for example

(1) a polymer obtained by copolymerizing a vinyl monomer (a) the homopolymer of which has a lower critical solution temperature in water with an other copolymerizable vinyl monomer (b);

(2) a cellulose substituted with alkyl, hydroxyalkyl, hydroxyalkylalkyl or polyalkyleneoxyl; and

(3) a polymer obtained by graft-polymerizing the above-mentioned vinyl polymer (a) or a vinyl monomer (c) having an ionic group with a polymer, such as methyl cellulose or hydroxypropyl cellulose having a lower critical solution temperature in water. Among the above, the polymer described in (1), particularly a water-soluble acrylamide polymer is preferable as the thermosensitive point of the resulting polymer can be easily controlled.

The vinyl monomer (a) for the polymer described in (1) includes, for example N-substituted acrylamide and its derivative, such as N-isopropyl (meth)acrylamide, N-n-propyl(meth)acrylamide, N,N-diethylacrylamide acryloylpiperidine, acryloylpyrrolidine or vinylcaprolactam, alkylvinylether, such as methylvinylether or ethylvinylether, and N-vinylalkylamide, such as N-vinylisobutylamide.

The vinyl monomer (b) includes, for example a vinyl monomer having ionicity, such as acrylic acid and its salt (sodium salt, potassium salt or calcium salt), 2-acrylamide-2-propanesufonic acid and its salt (sodium salt, potassium salt or calcium salt), N,N-dimethylaminopropylacrylamide and its salt (sulphate, monomethyl sulphate, dimethyl sulphate, methyl chloride) or N,N-dimethylaminoethyl (meth)acrylate and its salt (sulphate, monomethyl sulphate, dimethyl sulphate, methyl chloride), acrylamide derivative, such as acrylamide, diacetone acrylamide or tert-butylacrylamide, and (meth)acrylate, such as methyl (meth)acrylate, ethyl (meth)acrylate, butyl (meth)acrylate or hydroxyethyl (meth)acrylate.

A specific polymer described in (1) is preferably a polymer that comprises N-isopropylacrylamide as a main component and that is obtained by copolymerizing it with other vinyl monomer (b), and more preferably a polymer obtained by copolymerizing 75 to 99 mol % of N-isopropylacrylamide and 1 to 25 mol % of sodium acrylate as the polymer has an excellent fire extinguishing effect against tempura oil fires or oilstove fires.

The cellulose derivative described in (2) includes, for example an alkyl-substituted cellulose, such as methyl cellulose or ethyl cellulose, hydroxyalkyl-substituted cellulose, such as hydroxypropyl cellulose, hydroxyalkylalkyl-substituted cellulose, such as hydroxyethylmethyl cellulose, hydroxyethylethyl cellulose, hydroxyethylpropyl cellulose, hydroxypropylethyl cellulose, hydroxypropylmethyl cellulose, polyalkyleneoxyl-substituted cellulose, such as polyethyleneoxyl cellulose or polypropyleneoxyl cellulose, wherein the substituted cellulose derivatives have specific substituents, degree of substitution and molecular weight, and a cellulose derivative obtained by grafting a specific vinyl monomer and/or a specific ionic vinyl monomer into the above-mentioned polymer. These polymers may be used alone or in a combination of two or more polymers. Among the above-mentioned polymers, methyl cellulose and hydroxypropylmethyl cellulose are preferable.

Methyl cellulose has a methoxy content ranging from 26.0 to 33.0, preferably from 27.0 to 32.0.

Hydroxypropylmethyl cellulose has methoxy and hydroxypropyl contents ranging from 17.0 to 31.0 and not more than 15.0, preferably from 20.0 to 30.0 and not more than 13.0, respectively.

The vinyl monomer (c) having an ionic group for the polymer described in (3) includes, for example a vinyl monomer having an anionic group, such as (meth)acrylate (alkaline metal salt or ammonium salt), 2-(meth)acrylamide-2-methylpropane sulfonate (alkaline metal salt or ammonium salt), p-styrene sulfonate (alkaline metal salt or ammonium salt), vinyl sulfonate (alkaline metal salt or ammonium salt), methallyl sulfonate (alkaline metal salt or ammonium salt), 2-(meth)acryloyloxyethane sulfonate (alkaline metal salt or ammonium salt) or mono(2-meth)acryloyloxyethyl) acid phosphate (alkaline metal salt or ammonium salt), a vinyl monomer having a cationic group, such as several quaternary ammonium salts derived from (meth)acrylate derivatives having tertiary amino group, or several quaternary ammonium salts derived from (meth)acrylamide derivatives having tertiary amino group, a monomer of betaine type, such as an intramolecular salt-forming monomer having several amphoteric inonic groups derived from (meth)acrylate derivative having tertiary amino group, or an intramolecular salt-forming monomer having several amphoteric inonic groups derived from (meth)acrylamide derivative having tertiary amino group, and an acrylamide derivative having an amino acid salt. These monomers may be used alone or in a combination of two or more monomers. Among the above-mentioned monomers, the vinyl monomer having an anionic group is more preferable, and alkaline metal (meth)acrylate and alkaline metal 2-(meth)acrylamide-2-methylpropane sulfonate are particularly preferable. The technique on the graft polymerization is known well at present.

In the polymers prepared by the graft polymerization, a molar ratio of the above-mentioned vinyl monomer (a) and the above-mentioned vinyl monomer (c) having an ionic group varies with kind of monomers used, but it is preferable that an amount of the vinyl monomer (a) is not less than 50 mol %, particularly not less than 70 mol %. When the amount of the vinyl monomer (a) is less than 50 mol %, it is liable not to give an excellent hydrogel due to heat.

Specifically, a method for preparing a polymer can be exemplified as follows. For example, 80 to 99 mol % of N-isopropyl (meth)acrylamide as vinyl monomer (a) and 1 to 20 mol % of sodium acrylate as vinyl monomer (c) having an ionic group are graft-copolymerized to give a polymer.

The cellulose derivative has preferably a molecular weight not less than 15000, more preferably not less than 50000. When the molecular weight is less than 15000, it is liable that a water-mixture formed by adding the derivative into a fire extinguishing water has no sensitivity to heat.

Solidifying temperature of the thermosensitive polymer is not specifically limited, but it is necessary to be a temperature not less than one that the polymer does not gel at an ambient temperature to a temperature in midsummer, and it is preferable to be set at a temperature between 10° C. and 140° C. (a temperature of 100° C. or more is measured under pressure), particularly between 50° C. and 100° C.

Further, the present invention provides a fire extinguishing water obtained by dissolving the fire extinguishing agent containing the thermosensitive polymer into water.

Molecular weight and amount to be dissolved in water of the thermosensitive polymer are desirably set so that water containing the thermosensitive polymer can have a viscosity of 20 to 2000 mPa.s (30° C.) in a state of solution used for extinguishing fire and at a temperature range in which the thermosensitive polymer is water-soluble. When the viscosity is less than the lower limit, the resulting fire extinguishing water does not fully lead to a hydrogel, therefore it cannot be expected to exert high fire extinguishing and fire-spread preventing effects. On the other hand, when the viscosity is more than the higher limit, it is not preferable as transportation and flashing become difficult.

Although the concentration of the thermosensitive polymer varies depending on the kind and molecular weight thereof, 0.1 to 10% by weight on the basis of the amount of water is desirable, and an aqueous solution of 0.5 to 2% by weight is preferable. When the concentration is less than 0.1% by weight, solidification due to heat is not fully occurred. On the other hand, when the concentration is more than 10% by weight, it is not preferable as the resulting aqueous solution has too high viscosity and less fluidity in some cases.

The fire extinguishing water containing the thermosensitive polymer may contain any agents that have been conventionally used as a fire extinguishing agent, as the occasion demands. It is not any problem to use by mixing and dissolving in the fire extinguishing water, for example a fire extinguishing agent, such as ammonium salts, e.g., ammonium primary phosphate, ammonium secondary phosphate, ammonium carbonate, ammonium chloride or ammonium borate, or potassium salts, e.g., potassium acetate, potassium bicarbonate, potassium borate or potassium chloride, a flameproofing agent, an anionic surfactant and a surfactant as an introfier, such as sodium dioctylsulfosucuccinate, but also it ensures more effective extinction and fire-spread prevention as the flameproofing agent and the like can be prevented from scattering and run-off by the solidification of the thermosensitive polymer.

The fire extinguishing water of the present invention may further contain a heat cross-linking agent, such as urea formalin resin, methylol melamine resin or glyoxal, a freezing-point depressant, such as ethylene glycol, propylene glycol, glycerin or urea, as the occasion demands.

It is desirable to use the above-mentioned fire extinguishing agent, flameproofing agent, introfier, heat cross-linking agent or freezing-point depressant in an amount of 0.05 to 5% by weight based on the fire extinguishing water. The effect of added agents is low in a case of the amount of 0.05% by weight or less, and the thermosensitive polymer is separated out in a case of the amount 5% by weight or more, therefore these amounts are not preferable.

The fire extinguishing water of the present invention can be used as such for extinction by spraying in a similar manner as the general fire fighting. For example, the fire extinguishing water may be sprayed in a form of mist or water-drop through a hose, solidified in the fire and dropped and adhered on the surface of a burning object. Also, the fire extinguishing water may be spurted through a conventional fire hose to a burning object and solidified on the surface thereof.

Further, a previously prepared concentrated solution of a thermosensitive polymer may be sprayed on fire fighting with an addition of water for extinguishing fire.

### BEST MODE FOR CARRYING OUT THE INVENTION

Production examples of the thermosensitive polymer and test examples of the fire extinguishing agent and the fire extinguishing water will hereinafter be described, but the present invention never be limited to these examples. In the meanwhile, a thermosensitive point indicates a temperature at which the viscosity of a prepared aqueous solution exceeds 10000 mPa.s. In addition, “%” means “% by weight” unless otherwise stated.

### PRODUCTION EXAMPLE 1

### Production of Thermosensitive Polymer A

1360 g of desalted water was charged into a 2-L glass separable flask, and 222.6 g of N-isopropylacrylamide was dissolved therein with stirring. After the resulting solution was cooled to 10° C., 35.5 g of 2-acrylamide-2-methylpropane sulfonic acid was added and dissolved with stirring. While the solution was kept at a temperature of 15° C. or below, 48% sodium hydroxide solution was gradually added thereto and pH of the solution was adjusted to 7.0 to give a monomer preparing solution. After the monomer preparing solution was cooled to 0° C., it was degassed by bubbling nitrogen gas therein. After degassing, 14.7 ml of 10% aqueous solution of N,N,N′,N′-tetramethylethylenediamine and 7.4 ml of 10% aqueous solution of ammonium peroxo disulphate were added in that order as polymerization initiator to the solution to make a polymerization initiate. When the monomer preparing solution started to increase in viscosity by observation with eyes, stirring and bubbling of nitrogen gas were stopped, and then polymerization reaction was carried out for 16 hours at room temperature under sealing. After the polymerization was completed, the resulting polymer was taken out of the reaction container. The polymer was cut about 5 mm square, dried under vacuum at 40° C., ground and classified to give 260.4 g of thermosensitive polymer A having a particle size of 1 mm or less.

The viscosity of 1% aqueous solution of the resulting polymer A was 1600 mPa.s at 30° C. with B type viscometer. In addition, the viscosity of an aqueous solution comprising 1% polymer and 1% ammonium secondary phosphate as a flameproofing agent was 140 mPa.s at 30° C. with B type viscometer. The thermosensitive point: 55 to 60° C.

### PRODUCTION EXAMPLE 2

### Production of Thermosensitive Polymer B

1360 g of desalted water was charged into a 2-L glass separable flask, 208.5 g of N-isopropylacrylamide and 26.6 g of 80% aqueous solution of acrylic acid were charged thereinto and the monomer was dissolved therein with stirring. While monomer dissolved solution was kept at a temperature between 15 and 200° C., 48% sodium hydroxide solution was gradually added thereto and pH of the solution was adjusted to 7.0 to give a monomer preparing solution. After the monomer preparing solution was cooled to 0° C., it was degassed by bubbling nitrogen gas therein. After degassing, 14.7 ml of 10% aqueous solution of N,N,N′,N′-tetramethylethylenediamine and 7.4 ml of 10% aqueous solution of ammonium peroxo disulphate were added in that order as polymerization initiator to the solution to make a polymerization initiate. When the monomer preparing solution started to increase in viscosity by observation with eyes, stirring and bubbling of nitrogen gas were stopped, and then polymerization reaction was carried out for 16 hours at room temperature under sealing. After the polymerization was completed, the resulting polymer was taken out of the reaction container. The polymer was cut about 5 mm square, dried under vacuum at 40° C., ground and classified to give 230 g of thermosensitive polymer B having a particle size of 1 mm or less.

The viscosity of 1% aqueous solution of the resulting polymer B was 1600 mPa.s at 30° C. with B type viscometer. In addition, the viscosity of an aqueous solution comprising 1% polymer and 1% ammonium secondary phosphate as a flameproofing agent was 200 mPa.s at 30° C. with B type viscometer. The thermosensitive point: 55 to 60° C.

### PRODUCTION EXAMPLE 3

### Production of Thermosensitive Polymer C

Thermosensitive polymer C was prepared by carrying out the procedure similar to that of Production Example 2 except for the use of 29.3 g of 80% aqueous solution of acrylic acid.

The viscosity of 1% aqueous solution of the resulting polymer C was 2000 mPa.s at 30° C. with B type viscometer. In addition, the viscosity of an aqueous solution comprising 1% polymer and 1% ammonium secondary phosphate as a flameproofing agent was 200 mPa.s at 30° C. with B type viscometer. The thermosensitive point: 60 to 70° C.

### PRODUCTION EXAMPLE 4

### Production of Thermosensitive Polymer D

Thermosensitive polymer D was prepared by carrying out the procedure similar to that of Production Example 2 except that a monomer preparing temperature before adding the polymerization initiator was set to 20° C.

The viscosity of 1% aqueous solution of the resulting polymer D was 600 mPa.s at 30° C. with B type viscometer. In addition, the viscosity of an aqueous solution comprising 1% polymer and 1% ammonium secondary phosphate as a flameproofing agent was 150 mPa.s at 30° C. with B type viscometer. The thermosensitive point: 60 to 70° C.

### TEST EXAMPLE 1

1 g of thermosensitive polymer B was mixed and dissolved into 99 g of water containing 0.5% of ammonium secondary phosphate as a flameproofing agent. 20 ml of the resulting aqueous solution of polymer was placed in a glass screw test tube of 18 mm inner diameter and 180 mm length, sealed, heated at an arbitrary temperature and confirmed whether or not the solution had fluidity by observation with eyes. The results are indicated in Table 1. In the table, the indication “O” means that the whole of the solution is in a solid state (in a state of hydrogel) and the solution is not fluidized at all even when the test tube is slanted; the indication “Δ” means that most of the solution is in a thicken state, but any fluidity can still be confirmed; and the indication “x” means the solution is in a liquid state having fluidity.

TABLE 1
Results of temperature sensitivity test

| | | | | | | | |
|---|---|---|---|---|---|---|---|
| Temperature (° C.) | 40 | 50 | 55 | 60 | 65 | 70 | 75 |
| State of Solution | X | X | Δ | ◯ | ◯ | ◯ | ◯ |

In the meantime, the viscosity of 0.5% aqueous solution of ammonium secondary phosphate in which only ammonium secondary phosphate was dissolved without using thermosensitive polymer B was measured at the above-mentioned temperature with B type viscometer. Consequently, the solution had a viscosity of 10 mPa.s or less at a temperature of 75° C. or below.

### TEST EXAMPLE 2

1) Composition of Aqueous Solution of Thermosensitive Polymer

The composition of aqueous solutions of thermosensitive polymer used for the present test is shown in Table 2. Demineralized water was used as water and several components (% by weight) were added thereto thereby adjusting the whole to 100% by weight. In the table, DOSS.Na means sodium dioctylsulfosuccinate.

2) Measurement of Viscosity of Solutions

Each viscosity of solutions 1 and 2 shown in Table 2, a solution (solution 3A) that 1% of ammonium secondary phosphate was added to solution 3 and a solution (solution 3B) that 1% of ammonium hydrogen phosphate and 0.1% of sodium dioctylsulfosuccinate was added to solution 3 is shown in Table 3.

TABLE 2

| Component | Solution 1 | Solution 2 | Solution 3 |
|---|---|---|---|
| Thermosensitive Polymer A | 2.0 | | |
| Thermosensitive Polymer B | | 2.0 | |
| Thermosensitive Polymer C | | | 2.0 |
| NH₄H₂PO₄ | 1.0 | 1.0 | |
| DOSS-Na | 0.1 | 0.1 | |
| Demineralized Water | Reminder | Reminder | Reminder |

TABLE 3

| Temperature (° C.) | Solution 1 | Solution 2 | Solution 3A | Solution 3B |
|---|---|---|---|---|
| 30 | 240 | 140 | 200 | 180 |
| 40 | 140 | 40 | 120 | 150 |
| 50 | 870 | 9,650 | 200 | 100 |
| 60 | 18,800 | 84,000 | 10,000 | 700 |
| 70 | | | 25,000 | 23,000 |

3) Temperature Sensitivity Test of Solutions

Test Method:

i) The solution to be tested (sample) was added dropwise in an amount of 10 g, 20 g or 50 g on a metal plate of 13 cm diameter uniformly heated at 250° C. and the exchange of state was observed.

ii) The sample was warmed at a temperature near the thermosensitive point in a thermostat until the sample reached to an even temperature, and gelation thereof or perfectly solidified state was observed.

iii) Heating and cooling of the sample were repeated and the exchange of state was observed.

Result 1:

The results of test methods 1 and 2 are shown in Table 4. The length of time required for the moisture in the sample to evaporate from dropwise addition of the sample on the heated plate (test method 1) and whether or not the sample was solidified by warming it on the metal plate (test method 2) were determined.

TABLE 4
The time and state from dropwise addition of the sample on the plate
heated at 250° C. to evaporation

| | Time required to evaporate | | | |
|---|---|---|---|---|
| | (′ = minute; ″ = second) | | | Solidified |
| Sample | 10 g | 20 g | 50 g | state |
| Water | 1′22″23 | 2′02″54 | 6′59″69 | |
| Solution 1 | | | | |
| Solution 1 only | 15′ or | | | ◯ |
| | more | | | |
| Solution 1: Water = 2:1 | 9′48″43 | 14′28″20 | | ◯ |
| Solution 1: Water = 1:1 | 5′20″90 | | | ◯ |
| Solution 1: Water = 1:4 | 3′06″06 | | | Δ |
| Solution 1: Water = 1:10 | 2′22″57 | 3′31″06 | 5′15″84 | X |
| Solution 1: Water = 1:50 | 1′38″45 | | | X |
| Solution 2 | | | | |
| Solution 2 only | 15′ or | | | ◯ |
| | more | | | |
| Solution 2: Water = 2:1 | 14′05″30 | | | ◯ |
| Solution 2: Water = 1:1 | 8′34″01 | | | ◯ |
| Solution 2: Water = 1:4 | 2′40″62 | 3′50″21 | | Δ |
| Solution 2: Water = 1:10 | 2′04″02 | 2′44″59 | 5′29″04 | X |
| Solution 2: Water = 1:50 | 1′10″57 | 2′23″04 | 5′22″75 | X |
| Solution 3 | | | | |
| Solution 3 only | 14′15″77 | | | ◯ |
| Solution 3: Water = 2:1 | 14′05″30 | | | ◯ |
| Solution 3: Water = 1:1 | 8′46″41 | | | ◯ |
| Solution 3: Water = 1:4 | 2′47″43 | 3′25″83 | 13′45″83 | Δ |
| Solution 3: Water = 1:10 | 3′16″76 | 4′34″67 | 11′45″34 | X |
| Solution 3A | | | | |
| Solution 3A: Water = 1:1 | 20′08″85 | 23′41″93 | 38′14″55 | ◯ |
| Solution 3A: | 15′49″73 | 23′06″30 | | ◯ |
| Water = 1:2.5 | | | | |
| Solution 3A: Water = 1:4 | 3′09″78 | 4′17″15 | 7′29″56 | ◯ |
| Solution 3A: | 2′40″53 | 4′39″32 | 10′09″46 | Δ |
| Water = 1:10 | | | | |

Note: The indication “◯” means that the sample solidifies completely. The indication “Δ” means that the sample solidifies but is sponge-like. The indication “X” means that the sample dose not solidify.
In the meantime, when the sample was added dropwise on the plate, water was scattered but other components were not.

It is clear from the table indicated above that a solution in which about 4-fold amount of water is added to 2% aqueous solution of thermosensitive polymer also solidifies by warming. It is able to keep about 250-fold amount of water based on the amount of thermosensitive polymer.

Result 2:

A solution (solution 3A: water=1:1) in which an equivalent amount of water was added to the above-mentioned solution 3A was used as a sample in test method iii), the sample solidified by heating at 250° C. was left at an ambient temperature, and the state exchange of the sample was observed depending on a lowering of the temperature. The results are shown in Table 5.

TABLE 5

| | Sample (Solution 3A: Water = 1:1) | |
|---|---|---|
| | Temperature | |
| Time (h) | (° C.) | Solidified State |
| 0 | 250 | Complete solidification |
| 1 | 89 | Complete solidification |
| 4 | 61 | Complete solidification |
| 5 | 56 | Complete solidification |
| 6 | 45 | Softening (no fluidity) |
| 10 | 41 | Softening (no fluidity) |
| 15 | 34 | Liquefying (no fluidity) |

As clear from also the results shown in Table 5, after the fire extinguishing water of the present invention solidifies once, the solidified water remains on the face of a burning object and is not run off even when it is cooled to a temperature near an ambient temperature.

### TEST EXAMPLE 3

A combination of the fire extinguishing agent or water of the present invention with a conventional fire extinguishing agent or other components was examined.

Aqueous solutions in which thermosensitive polymer C prepared in Production Example 3 as a thermosensitive polymer is contained in a proportion shown in Table 6 was observed on the solidified state at each temperature. The results are shown in Table 6.

TABLE 6

| | Temperature (° C.) | | | |
|---|---|---|---|---|
| Composition | 60 | 65 | 70 | 75 |
| Polymer C 1% + | ◯ white | ※ separation | ※ | ※ |
| Ammonium | jelly-like | into white material | ditto to left | ditto to left |
| Phosphate 1% | | and liquid | | |
| Polymer C 1% + | ⊚ | ⊚ | ⊚ | ⊚ |
| Ammonium | white solid | ditto to left | ditto to left | ditto to left |
| Phosphate 0.5% | | | | |
| Polymer C 0.5% + | ◯ | ◯ | ※ | |
| Ammonium | white, white | ditto to left | ditto to left | ditto to left |
| Phosphate 0.5% | opaque | | | |
| Polymer C 0.5% + | ◯ | ◯ | ◯ jelly-like, | separation into |
| Ammonium | transparent | a little white | drop in | two phases |
| Phosphate 0.25% | | | viscosity | |
| Polymer C 1% + + | Δ | ◯ | ⊚ | ⊚ |
| Na₂CO₃ 1% | | | | jelly-like |
| Polymer C 1% + | Δ | Δ | ◯ | ⊚ |
| Na₂CO₃ 0.5% | | | | jelly-like |
| Polymer C 0.5% + | X | X | X | Δ |
| Na₂CO₃ 0.5% | | | | |
| Polymer C 0.5% + | X | Δ | Δ | Δ |
| Na₂CO₃ 1% | | | | |

Note: The indication “⊚” means that the sample is complete solid, the indication “◯” means that the sample is solid (inferior to “⊚”), the indication “※” means that the sample is solidified but separated partly, the indication “Δ” means that the sample is soft (is not solid), and the indication “X” means that the sample is complete liquid.

As clear from the results shown in Table 6, the fire extinguishing water of the present invention solidifies even when other flamproofing agent (ammonium phosphate) and inorganic material (sodium carbonate) are dissolved therein. This means that the fire extinguishing water of the present invention can use water in rivers.

### TEST EXAMPLE 4

100 g of thermosensitive polymer synthesized in Production Example 1 as a fire extinguishing agent, 50 g of ammonium secondary phosphate and 5 g of sodium dioctylsulfosuccinate were dissolved in 4845 g of tap water to give a fire extinguishing water. 3-L of the obtained fire extinguishing water was charged into a fire extinguisher with a nozzle of 2 mmφ diameter (produced by Hatta Co., Ltd.: a fire extinguisher for fire-fighting exercise; Tester 7), and a pressure in the extinguisher was increased to 5×10⁵ Pa with nitrogen gas. After a fire was set up to a stacked woods prepared by piling up 20 layers each of which is composed of five pine bars (each bar of 3 cm square and 50 cm length) in parallel, and the stacked woods were in a independent burning state, a fire fighting test was done by spraying the fire extinguishing water from the fire extinguisher to the stacked woods. The test was repeated 10 times under same condition, and average time (second) from start of water-spraying to extinction of flame and amount of water (kg) used during the period were measured. Consequently, the fire extinguishing water had 96.7 kg.s of a fire-extinction efficiency calculated by multiplying the average time by the amount of water. Further, during fire fighting and immediately after extinction of flame, it was not recognized that the sprayed fire extinguishing water was scattered or run off.

### TEST EXAMPLE 5

A fire fighting test was carried out by the procedure similar to that of Test Example 4 except for the use of a fire extinguishing water prepared by dissolving 50 g of thermosensitive polymer synthesized in Production Example 1, 50 g of ammonium secondary phosphate and 5 g of sodium dioctylsulfosuccinate in 4845 g of tap water. Consequently, the fire extinguishing water had 100 kg.s of a fire-extinction efficiency. Further, during fire fighting and immediately after extinction of flame, it was not recognized that the sprayed fire extinguishing water was scattered or run off.

### TEST EXAMPLE 6

A fire fighting test was carried out by the procedure similar to that of Test Example 4 except for the use of 3 kg of 1% aqueous solution prepared with 100 g of thermosensitive polymer synthesized in Production Example 4. Consequently, the fire extinguishing water had 97.6 kg.s of a fire-extinction efficiency. Further, during fire fighting and immediately after extinction of flame, it was not recognized that the sprayed fire extinguishing water was scattered or run off, and nor that the stacked woods were fired again even when they were left for 1 hour after fire control.

### TEST EXAMPLE 7

A fire fighting test was carried out by the procedure similar to that of Test Example 4 except for the use of a fire extinguishing water prepared by dissolving 50 g of thermosensitive polymer synthesized in Production Example 4, 50 g of ammonium secondary phosphate and 5 g of sodium dioctylsulfosuccinate in 4845 g of tap water. Consequently, the fire extinguishing water had 58.3 kg.s of a fire-extinction efficiency. Further, during fire fighting and immediately after extinction of flame, it was not recognized that the sprayed fire extinguishing water was scattered or run off.

### TEST EXAMPLE 8

979 g of pure water, 10 g of methyl cellulose (methoxyl content 29.8%, molecular weight 350,000), 10 g of ammonium secondary phosphate and 1 g of sodium dioctylsulfosuccinate were placed in 1-L beaker, mixed and dissolved. The viscosity of the resulting 1% aqueous solution of polymer was 277 mPa.s at 20° C. with B type viscometer. Further, the thermosensitive point of the solution was 45 to 50° C.

3L of the fire extinguishing water prepared as described above was charged in a water fire extinguisher and a pressure in the extinguisher was increased to 7×10⁵ Pa with compressed air. A fire fighting test was carried out by the procedure similar to that of Test Example 4 with the extinguisher. Consequently, the fire-extinction efficiency in this test was 80.2 kg s.

### TEST EXAMPLE 9

979 g of pure water, 10 g of hydroxypropyl methyl cellulose (methoxyl content 29.0%, hydroxypropoxyl content 6.2%, molecular weight 380,000), 10 g of ammonium secondary phosphate and 1 g of sodium dioctylsulfosuccinate were placed in 1-L beaker, stirred and dissolved. The viscosity of the resulting 1% aqueous solution of polymer was 290 mPa.s at 20° C. with B type viscometer. Further, the thermosensitive point of the solution was 65 to 70° C.

3L of the fire extinguishing water prepared as described above was charged in a water fire extinguisher and a pressure in the extinguisher was increased to 7×10⁵ Pa with compressed air. A fire fighting test was carried out by the procedure similar to that of Test Example 4 with the extinguisher. Consequently, the fire-extinction efficiency in this test was 90.2 kg.s.

### TEST EXAMPLE 10

10 g of methyl cellulose (methoxyl content 29.6%, molecular weight 120,000) was added in 990 g of an aqueous solution containing 2.0% of ammonium secondary phosphate as a flameproofing agent and of 0.2% of sodium dioctylsulfosuccinate as an introfier in 1-L beaker, stirred and dissolved. The viscosity of the resulting 1% aqueous solution of polymer was 26 mPa.s at 20° C. with B type viscometer. Further, the thermosensitive point of the solution was 55 to 60° C.

3L of the fire extinguishing water prepared as described above was charged in a water fire extinguisher and a pressure in the extinguisher was increased to 7×10⁵ Pa with compressed air. A fire fighting test was carried out by the procedure similar to that of Test Example 4 with the extinguisher. Consequently, the fire-extinction efficiency in this test was 102.5 kg.s.

### COMPARATIVE TEST EXAMPLE 1

A fire fighting test was carried out by the procedure similar to that of Test Example 4 except for the use of a fire extinguishing water prepared by dissolving 50 g of ammonium secondary phosphate and 5 g of sodium dioctylsulfosuccinate in 4945 g of tap water. Consequently, the fire extinguishing water had 132.2 kg.s of a fire-extinction efficiency. Further, during fire fighting and immediately after extinction of flame, it was recognized that the sprayed fire extinguishing water was scattered or run off.

### COMPARATIVE TEST EXAMPLE 2

A fire fighting test was carried out by the procedure similar to that of Test Example 4 except for the use of tap water as a fire extinguishing water. Consequently, the fire extinguishing water had 255.2 kg.s of a fire-extinction efficiency. Further, during fire fighting and immediately after extinction of flame, it was recognized that the sprayed fire extinguishing water was scattered or run off.

Further, the stacked woods were fired again to a state akin to burning state about 20 minutes after the fire control was completed.

### TEST EXAMPLE 11

500 ml of soybean oil in a round-bottomed pan of 250 mm diameter and 70 mm depth was heated on a stove and ignited a fire. 30 seconds after the fire was ignited, 300 ml of 1% aqueous solution of thermosensitive polymer B synthesized in Production Example 2 in stainless steel jug with a handle was poured in the pan all at once, the time from the pour of the solution to extinction was measured, and the state of flame was observed with eyes. Consequently, the time required to extinction was 3 seconds, and it was not observed that the flame blazed up from the pour of the fire extinguishing solution to extinction. Further, after extinction it was recognized that the pan was covered with a film-like hydrogel made of the fire extinguishing agent, and the oil did not ignite again.

### TEST EXAMPLE 12

A test was carried out by the procedure similar to that of Test Example 11 except for the use of a fire extinguishing water comprising 1% of thermosensitive polymer B, 1% of ammonium secondary phosphate and 0.1% of sodium dioctylsulfosuccinate. Consequently, the time required to extinction was 7 seconds, and it was not observed that the flame blazed up from the pour of the fire extinguishing solution to extinction. Further, after extinction it was recognized that coagulates of hydrogel made of the fire extinguishing agent were present in the oil, and the oil did not ignite again.

### TEST EXAMPLE 13

A test was carried out by the procedure similar to that of Test Example 11 except for the use of a fire extinguishing water comprising 1% aqueous solution of thermosensitive polymer D prepared in Production Example 4. Consequently, the time required to extinction was 2 seconds, and it was not observed that the flame blazes up from the pour of the fire extinguishing solution to extinction. Further, after extinction it was recognized that that the pan was covered with a film-like hydrogel made of the fire extinguishing agent, and the oil did not ignite again.

### TEST EXAMPLE 14

10 g of methyl cellulose (methoxyl content 29.8%, molecular weight 350,000) was added to 990 g of pure water in 1-L beaker, dispersed and dissolved with stirring. The viscosity of the resulting 1% aqueous solution of polymer was 255 mPa.s at 20° C. with B type viscometer. Further, the thermosensitive point of the solution was 55 to 60° C.

A test was carried out by the procedure similar to that of Test Example 11 except for the use of the aqueous solution. Consequently, the time required to extinction was 16 seconds, and the flame diffused slightly from the pour of the fire extinguishing solution to extinction.

### TEST EXAMPLE 15

10 g of hydroxypropyl methyl cellulose (methoxyl content 29.0%, hydroxypropoxyl content 6.2%, molecular weight 380,000) was added to 990 g of pure water in 1-L beaker, dispersed and dissolved with stirring. The viscosity of the resulting 1% aqueous solution of polymer was 268 mPa.s at 20° C. with B type viscometer. Further, the thermosensitive point of the solution was 70 to 75° C.

A test was carried out by the procedure similar to that of Test Example 11 except for the use of the aqueous solution. Consequently, the time required to extinction was 13 seconds, and the flame diffused slightly from the pour of the fire extinguishing solution to extinction.

### COMPARATIVE TEST EXAMPLE 3

A test was carried out by the procedure similar to that of Test Example 11 except for the use of an aqueous solution prepared by dissolving potassium acetate and potassium tetra-borate in a proportion of 25% and 5%. Consequently, the time required to extinction was 9 seconds, but the flame blazed up immediately after the pour of the fire extinguishing solution and oil was scattered around. After extinction, re-ignition was not recognized.

### EFFECT OF THE INVENTION

It is necessary to meet the following conditions in order to use water containing the thermosensitive polymer of the present invention as a fire extinguishing water:

i) the water is still liquid at a temperature between an ambient temperature and a temperature a little higher than an ambient temperature as it is used in fire fighting;

ii) the water is solidified immediately by only combustion heat due to a fire;

iii) the water is not decomposed even when it is subjected to heat of a fire; and

iv) the water is not fluidized even when a burned object is cooled to an ambient temperature after extinction.

It is recognized from the above-mentioned Test Examples that the fire extinguishing agent of the present invention and fire extinguishing water prepared by dissolving it in water meet these conditions and that the agent and water have effects sufficient for extinguishing fire and checking the spread of fire.

Although a solution containing 2% thermosensitive polymer as a stock solution for adjustment have a viscosity 60 to 300 times higher than water, the solution is stable in a state of liquid up to about 60° C., therefore the solution can be used with water for extinguishing fire without solidification as a concentrate solution in a fire. In addition, when the solution is used along with water in rivers, the fire extinguishing water prepared therefrom can be solidified similarly. Therefore, the solution can be used also for forest and wood fires besides fires in urban area and oil fires.

What is claimed is:

1. A fire extinguishing agent characterized by comprising a thermosensitive polymer that is water-soluble at a temperature not more than a specific preset temperature and that solidifies by containing water therein at a temperature not less than the preset temperature.

2. The fire extinguishing agent according to claim 1, wherein the solidified thermosensitive polymer is a hydrogel.

3. The fire extinguishing agent according to claim 1 or 2, wherein the thermosensitive polymer is a water-soluble polyacrylamide polymer.

4. The fire extinguishing agent according to any one of claims 1 to 3, wherein the thermosensitive polymer is a polymer comprising N-isopropylacrylamide as a main component.

5. The fire extinguishing agent according to any one of claims 1 to 4, wherein the thermosensitive polymer is a polymer obtained by copolymerizing 75 to 99 mol % of N-isopropylacrylamide and 1 to 25 mol % of sodium acrylate.

6. The fire extinguishing agent according to claim 1, wherein the thermosensitive polymer is a cellulose derivative.

7. The fire extinguishing agent according to claim 6, wherein the cellulose derivative has a molecular weight not less than 15000.

8. The fire extinguishing agent according to claim 6 or 7, wherein the cellulose derivative is one or more selected from alkyl-substituted cellulose, hydroxyalkyl-substituted cellulose, hydroxyalkylalkyl-substituted cellulose, polyalkyleneoxyl-substituted cellulose and a cellulose obtained by grafting a vinyl monomer.

9. The fire extinguishing agent according to claim 8, wherein the alkyl-substituted cellulose is composed of mainly methyl cellulose (methoxyl group %: 26 to 33).

10. The fire extinguishing agent according to claim 8, wherein the hydroxyalkylalkyl-substituted cellulose is composed of mainly hydroxypropylmethyl cellulose (methoxyl group %: 17 to 31, hydroxypropyl group %: no more than 15).

11. The fire extinguishing agent according to claim 8, wherein the vinyl monomer is one that the homopolymer thereof has a lower critical solution temperature in a state of aqueous solution.

12. The fire extinguishing agent according to claim 8, wherein the vinyl monomer is one having an anion group.

13. A fire extinguishing water characterized by dissolving the fire extinguishing agent according to any one of claims 1 to 12 into water.

14. The fire extinguishing water according to claim 13, containing a fire extinguishing agent, a flameproofing agent or an introfier besides the thermosensitive polymer.

15. The fire extinguishing water according to claim 14, wherein the fire extinguishing agent is one or more selected from ammonium primary (secondary) phosphate, potassium bicarbonate, potassium borate and potassium acetate.

16. The fire extinguishing water according to claim 14, wherein the introfier is dioctylsulfosuccinate.

17. The fire extinguishing water according to any one of claims 13 to 16, wherein the viscosity of the aqueous solution is 20 to 2000 mPa.s (30° C.).

18. A method for extinguishing fire characterized by using the fire extinguishing water according to any one of claims 13 to 17.
